(19) United States
(12) Patent Application Publication
(10) Pub. No.: US 2026/0320734 A1
(43) Pub. Date: Oct. 15, 2026

(54) IMAGE PROCESSING METHOD AND APPARATUS, DISPLAY APPARATUS, AND VIRTUAL REALITY DISPLAY SYSTEM

(71) Applicants: BEIJING BOE DISPLAY TECHNOLOGY CO., LTD., Beijing (CN); BOE TECHNOLOGY GROUP CO., LTD., Beijing (CN)

(72) Inventors: Zhifu Li, Beijing (CN); Jinghua Miao, Beijing (CN); Wenyu Li, Beijing (CN); Chaoquan Yao, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 19/484,078

(22) PCT Filed: Apr. 18, 2024
(86) PCT No.: PCT/CN2024/088656

§ 371 Date: Nov. 13, 2025

(30) Foreign Application Priority Data
May 17, 2023 (CN) 202310559344.5

(51) Int. Cl. G06T 3/40; G06F 3/01; G06V 10/75

(52) U.S. Cl. CPC G06T 3/40; G06F 3/013; G06V 10/751

(57) ABSTRACT

An image processing method is provided. The method includes: determining, from an original image of a current frame, a corresponding first image based on a user's gaze region; and determining a corresponding second image based on the original image of the current frame, where a resolution of the second image is smaller than a solution of the first image; determining a similarity between the second image corresponding to the current frame and a second image corresponding to a previous frame; and transmitting a target image based on the similarity, where the target image is determined to be the first image in response to the similarity being greater than or equal to a preset threshold.

### CROSS REFERENCE TO RELATED APPLICATION(S)

This application is a Section 371 National Stage Application of International Application No. PCT/CN2024/088656, filed on Apr. 18, 2024, which claims priority to Chinese Patent Application No. 202310559344.5, filed on May 17, 2023, entitled “IMAGE PROCESSING METHOD AND APPARATUS, DISPLAY APPARATUS, AND VIRTUAL REALITY DISPLAY SYSTEM”, the entire contents of which are incorporated herein by reference in their entireties.

### TECHNICAL FIELD

The present disclosure relates to a field of image processing technology, and in particular to an image processing method and apparatus, a display apparatus, and a virtual reality display system.

### BACKGROUND

With the development of virtual reality (VR) technology, users' demands for the immersion and comfort provided by VR are continuously increasing, which poses significant challenges to image processing technology.

For large-scale VR applications, due to the limited processing capability of a processor in a VR device, a split-type method is adopted, that is, a high-performance server is used for complex image processing, so as to achieve reliable and fast data processing. However, at present, VR image transmission involves full high-definition images, and with an improvement of video refresh rates and screen definitions, the volume of data transmitted over the network continues to grow. This may cause a heavy burden on network bandwidth pressure, making it difficult to meet real-time requirements, and leading to problems such as latency and freezing are prone to occur, thereby impacting the user experience.

### SUMMARY

According to a first aspect of the present disclosure, an image processing method is provided, including: determining, from an original image of a current frame, a corresponding first image based on a user's gaze region; and determining a corresponding second image based on the original image of the current frame, where a resolution of the second image is smaller than a solution of the first image; determining a similarity between the second image corresponding to the current frame and a second image corresponding to a previous frame; and transmitting a target image based on the similarity, where the target image is determined to be the first image in response to the similarity being greater than or equal to a preset threshold.

Optionally, the determining a similarity between the second image corresponding to the current frame and a second image corresponding to a previous frame includes: determining a difference between a pixel value at each position in the second image of the current frame and a pixel value at a corresponding position in the second image of the previous frame; and weighting the determined differences to determine the similarity.

Optionally, the weighting differences in pixel values at each position includes: in each of the second image of the current frame and the second image of the previous frame, expanding from a user's gaze point serving as a center by a specified step size to a target movement position, so as to determine a first pixel region in the second image of the current frame and a second pixel region in the second image of the previous frame for the target movement position respectively; summing differences in pixel values at corresponding positions between the first pixel region and the second pixel region, so as to acquire a sum corresponding to the target movement position; weighting sums corresponding to respective target movement positions; and determining the similarity based on a result of the weighting.

Optionally, the weighting sums corresponding to respective target movement positions includes: determining a weight value of a sum corresponding to each target movement position in the weighting based on a spacing between the target movement position and the user's gaze point; and weighting the sums corresponding to the respective target movement positions using the weight value.

Optionally, the method further includes: before determining the first image, performing, in response to a presence of a region, not covered by the original image, in the user's gaze region, coordinate translation on the user's gaze region, such that the user's gaze region falls within a range of the original image.

Optionally, the transmitting a target image based on the similarity includes: transmitting, in response to the similarity being less than the preset threshold, the first image corresponding to the current frame and the second image corresponding to the current frame.

Optionally, the method further includes: acquiring coordinates of the user's gaze point; and expanding a specified range outward with the coordinates of the user's gaze point as a center, so as to determine the user's gaze region.

Optionally, the method further includes: updating a cached second image corresponding to the previous frame using the second image corresponding to the current frame.

According to a second aspect of the present disclosure, an image processing method is provided, including: receiving a target image of a current frame, where the target image includes a first image, the target image is determined based on a similarity between a second image corresponding to the current frame and a second image corresponding to a previous frame, the first image is determined from an original image of the current frame based on a user's gaze region, the second image is determined based on the original image of the current frame, and a resolution of the second image is smaller than a solution of the first image; and the target image is determined to be the first image in response to the similarity being greater than or equal to a preset threshold; and fusing the received first image corresponding to the current frame and the second image corresponding to the previous frame, so as to acquire a to-be-displayed image.

Optionally, the target image includes the first image corresponding to the current frame and the second image corresponding to the current frame, and the method further includes: fusing the first image corresponding to the current frame and the second image corresponding to the current frame, so as to acquire the to-be-displayed image.

Optionally, the fusing includes: performing size restoration on a to-be-fused second image to acquire a corresponding third image, where a size of the third image is equal to a size of a corresponding original image, and the to-be-fused second image is the second image corresponding to the current frame or the second image corresponding to the previous frame; fusing the first image and the third image such that the first image covers a corresponding position of the third image, so as to acquire a corresponding fourth image; and smoothing a fusion boundary in the fourth image, so as to acquire the to-be-displayed image.

Optionally, the weighting sums corresponding to respective target movement positions comprises: calculating a result of the weighting corresponding to the respective target movement positions by:

$$sum = {\sum }_{j = 1}^{m} {W}_{j} {\sum }_{i = 1}^{n} {( \vert δ r \vert + \vert δ g \vert + \vert δ b \vert )}_{i} / 3 / 255$$

where sum represents the result of the weighting of the two second images, Wⱼ represents a weight value of a j^{th} target movement position, j represents the serial number of a target movement position, n represents a total number of pixels in the pixel region corresponding to the target movement position, i represents the serial number of a pixel in the pixel region corresponding to the target movement position, m represents a total number of target movement positions, δr, δg and δb respectively represent differences in R, G and B pixel values at corresponding positions of the two second images, and |•| represents taking an absolute value.
the determining a weight value of a sum corresponding to each target movement position in the weighting based on a spacing between the target movement position and the user's gaze point comprises: calculating the weight value by:

$${W}_{j} = 0.5 \times \frac{1}{( 1 + exp ( - \frac{5}{1920} \times \vert s \vert ) )}$$

where Wⱼ represents a weight value of a j^{th} target movement position, j represents the serial number of a target movement position, S represents a spacing between the j^{th} target movement position and the user's gaze point.

According to a third aspect of the present disclosure, an image processing device is provided, including an image determination module, a similarity determination module and a transmission module, where the image determination module is configured to determine a corresponding first image from an original image of a current frame based on a user's gaze region, and determine a second image corresponding to the current frame based on the original image of the current frame, where a resolution of the second image is smaller than a solution of the first image; the similarity determination module is configured to determine a similarity between the second image corresponding to the current frame and a second image corresponding to a previous frame; and the transmission module is configured to transmit a target image based on the similarity, where the target image is determined to be the first image in response to the similarity being greater than or equal to a preset threshold.

According to a fourth aspect of the present disclosure, an image processing device is provided, including a receiving unit and a processing unit, where the receiving unit is configured to receive a target image of a current frame, where the target image includes a first image, the target image is determined based on a similarity between a second image corresponding to the current frame and a second image corresponding to a previous frame, the first image is determined from an original image of the current frame based on a user's gaze region, the second image is determined based on the original image of the current frame, and a resolution of the second image is smaller than a solution of the first image; and the target image is determined to be the first image in response to the similarity being greater than or equal to a preset threshold; and the processing unit is configured to fuse the received first image corresponding to the current frame and the second image corresponding to the previous frame, so as to acquire a to-be-displayed image.

According to a fifth aspect of the present disclosure, a display apparatus is provided, including an image processor and a display, where the image processor is configured to implement the method according to any one of the above-mentioned embodiments; and the display is configured to display the to-be-displayed image.

According to a sixth aspect of the present disclosure, a virtual reality display system is provided, including the display apparatus according to the above-mentioned embodiments.

According to a seventh aspect of the present disclosure, a non-transitory computer-readable medium having a computer program stored therein is provided, where the computer program, when executed by a processor, is configured to implement the image processing method according to any one of the above-mentioned embodiments.

According to an eighth aspect of the present disclosure, an electronic device is provided, including: one or more processors; and a storage device configured to store one or more programs, where the one or more programs, when executed by the one or more processors, cause the one or more processors to implement the image processing method according to the above-mentioned embodiments.

It will be understood that the above-mentioned general descriptions and the following detailed descriptions are merely exemplary and explanatory, and are not intended to limit the present disclosure.

### BRIEF DESCRIPTION OF THE DRAWINGS

The accompanying drawings, which are incorporated into and constitute a part of the specification, illustrate embodiments consistent with the present disclosure and serve to explain the principles of the present disclosure together with the specification. Obviously, the accompanying drawings in the following description are only some embodiments of the present disclosure. For those of ordinary skill in the art, other drawings may be obtained based on these accompanying drawings without creative efforts.

FIG. 1 schematically shows a first flowchart of an image processing method according to an embodiment of the present disclosure.

FIG. 2 schematically shows a flowchart of a coordinate translation process of a first image according to an embodiment of the present disclosure.

FIG. 3(a) schematically shows a schematic diagram of positions of an original image and a first image of a current frame according to an embodiment of the present disclosure.

FIG. 3(b) schematically shows a first image of a current frame according to an embodiment of the present disclosure.

FIG. 3(c) schematically shows a second image of a current frame according to an embodiment of the present disclosure.

FIG. 4 schematically shows a schematic diagram of pixel regions respectively corresponding to target movement positions divided based on a user's gaze point according to an embodiment of the present disclosure.

FIG. 5 schematically shows a second flowchart of an image processing method according to another embodiment of the present disclosure.

FIG. 6 schematically shows a flowchart of image fusion processing according to an embodiment of the present disclosure.

FIG. 7 schematically shows a schematic diagram of three rounds of filtering processing according to an embodiment of the present disclosure.

FIG. 8 schematically shows a third flowchart of an image processing method according to an embodiment of the present disclosure.

FIG. 9 schematically shows a first block diagram of an image processing device according to an embodiment of the present disclosure.

FIG. 10 schematically shows a second block diagram of an image processing device according to an embodiment of the present disclosure.

FIG. 11 schematically shows a block diagram of a display apparatus according to an embodiment of the present disclosure.

FIG. 12 schematically shows a schematic diagram of modules of an electronic device according to an embodiment of the present disclosure.

### DETAILED DESCRIPTION OF EMBODIMENTS

Exemplary embodiments will be described more fully with reference to the accompanying drawings. However, the exemplary embodiments may be implemented in various forms and shall not be construed as being limited to the examples set forth herein. These embodiments are provided to make the present disclosure more comprehensive and complete, and to fully convey the concept of the exemplary embodiments to those skilled in the art.

In addition, the described features, structures, or characteristics may be combined in any suitable manner in one or more embodiments. In the following descriptions, many specific details are provided to provide a thorough understanding of embodiments of the present disclosure. However, those skilled in the art will appreciate that the technical solutions of the present disclosure may be practiced without one or more of specific details, or other methods, components, apparatuses, steps, etc., may be used. In other cases, well-known methods, apparatuses, implementations, or operations are not shown or described in detail, so as to avoid obscuring the aspects of the present disclosure.

The block diagrams shown in the accompanying drawings are merely functional entities, and do not necessarily correspond to physically independent entities. That is, these functional entities may be implemented in a form of software, or implemented in one or more hardware modules or integrated circuits, or implemented in different networks and/or processor apparatuses and/or microcontroller apparatuses.

The flowcharts shown in the accompanying drawings are merely exemplary, and do not necessarily include all contents and operations/steps, nor do they necessarily need to be executed in the described order. For example, some operations/steps may be decomposed, and some operations/steps may be combined or partially combined, so the actually executed sequences may be changed according to actual situations.

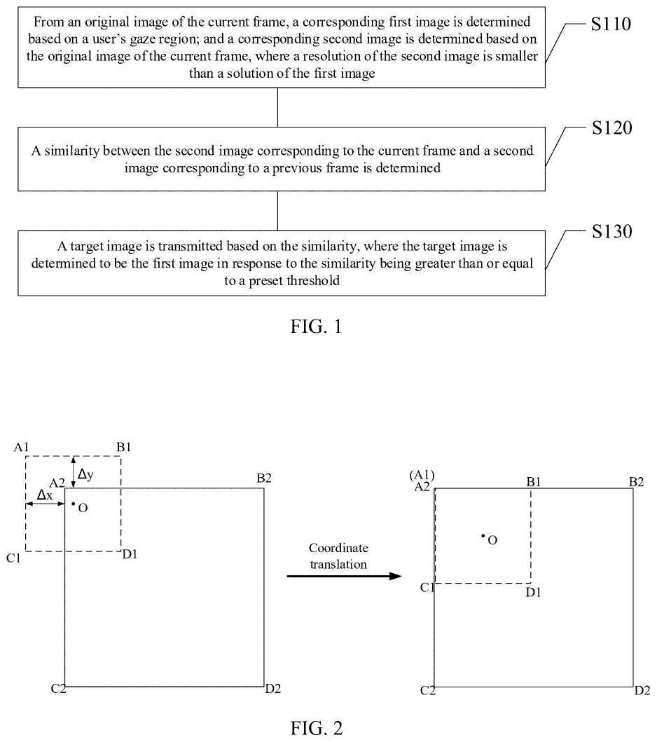

An embodiment of the present disclosure provides an image processing method. FIG. 1 shows a flowchart of an image processing method. As shown in FIG. 1, the image processing method includes at least the following steps S110 to S130.

In step S110, a first image corresponding to a current frame is determined from an original image of the current frame based on a user's gaze region; and a second image corresponding to the current frame is determined based on the original image of the current frame, where a resolution of the second image is smaller than a solution of the first image.

In step S120, a similarity between the second image corresponding to the current frame and a second image corresponding to a previous frame is determined.

In step S130, a target image is transmitted based on the similarity, where the target image is determined to be the first image in response to the similarity being greater than or equal to a preset threshold.

According to the image processing method provided in the embodiments of the present disclosure, on one hand, the first image of the current frame is determined based on the user's gaze region and then transmitted, which may ensure the image clarity of a user's region of interest and ensure information integrity of the user's region of interest, thereby ensuring the user experience. On the other hand, the second image of the current frame may be determined based on the original image of the current frame, where the resolution of the second image is smaller than the solution of the first image, and in the case that the similarity between the second image of the current frame and the second image of the previous frame is greater than the preset threshold, only the first image of the current frame is transmitted, so that in the case of a high similarity between two adjacent frames, a data transmission volume of the current frame may be reduced, a network bandwidth pressure may be alleviated, ensure real-time data transmission, and avoid freezing and high latency phenomenon, thereby improving the user experience.

In order to make the technical solutions of the present disclosure clearer, the steps of the image processing method will be described below.

In step S110, the first image corresponding to the current frame is determined from the original image of the current frame based on the user's gaze region; and the second image corresponding to the current frame is determined based on the original image of the current frame.

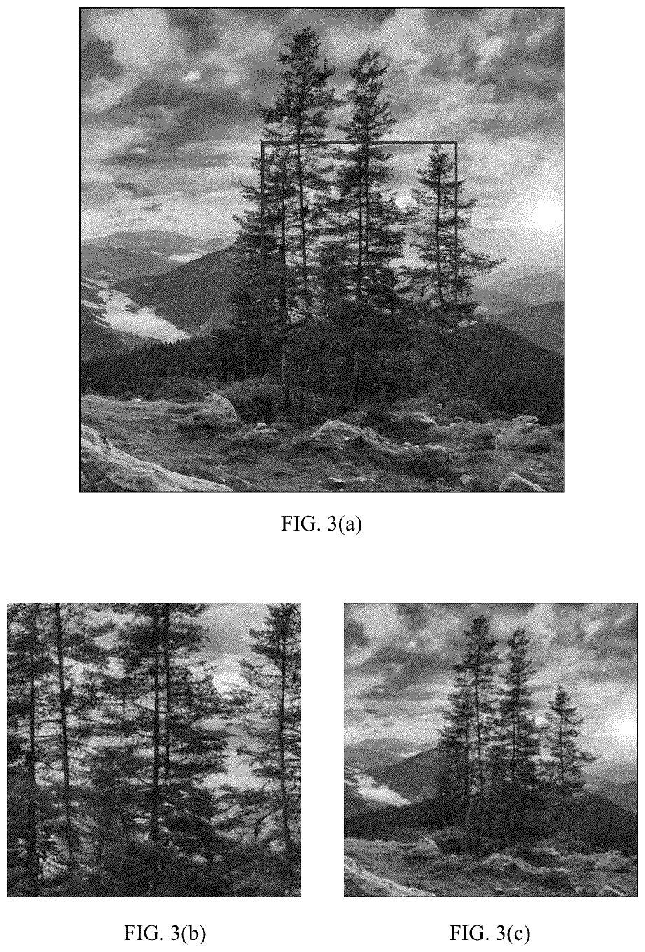

In an exemplary embodiment, image compression processing may be performed on the original image of the current frame to reduce the resolution of the original image, so as to obtain the second image corresponding to the current frame. For example, an average pooling operation may be performed on the original image to compress the original image. A compression parameter of the image may be set as desired. For example, the original image may be compressed to ¼ of its original size through 2×2 average pooling. The second image may be a low-resolution version of the original image, and the resolution of the second image is smaller than the resolution of the first image. As shown in FIG. 3, FIG. 3(a) is the original image of the current frame, and the box in FIG. 3(a) indicates a position of the first image. FIG. 3(b) is the first image corresponding to the current frame. FIG. 3(c) is the second image corresponding to the current frame. According to this example, a bandwidth pressure of network transmission may be reduced by lowering a resolution of a transmitted image.

In this exemplary embodiment, the original image refers to a high-resolution image to be transmitted, such as a 4k×4k image. For example, the user's gaze region in the original image of the current frame may be used as the first image, or the user's gaze region may be appropriately enlarged or reduced to serve as the first image, which will not be limited in this example.

In some embodiments, coordinates of the user's gaze point may be acquired first; and then a specified range is expanded outward from the coordinates of the user's gaze point as a center, so as to determine the user's gaze region.

In an exemplary embodiment, the coordinates of the user's gaze point may be determined using an eye tracking technology. The eye tracking technology is implemented based on a physiological structure of an eye, which may include, for example, any one of a sclera-iris boundary method, a pupil tracking method, and a pupil-corneal reflection method.

For example, taking the pupil-corneal reflection method as an example: on a device side, an eye tracker of a device (such as a VR device, a mobile phone, etc.) around a pupil emits infrared light toward the user's eyes, and an infrared camera collects infrared light reflected from the cornea and retina. Based on physical properties of the eye, under a premise that relative positions of the light source and the head remain unchanged, a light spot formed by corneal reflection does not move, while light reflected from the retina exits through the pupil. Therefore, a direction of the light reflected from the retina indicates an orientation of the pupil. An eye movement direction may be determined based on an angle between the light reflected by the cornea and by the pupil, and subsequently, the gaze point in a camera coordinate system is determined. Coordinates of the gaze point on an image may be obtained by transforming the gaze point in the camera coordinate system to an image coordinate system. The device side sends the coordinates to an image processing side (e.g., an image rendering server) at a certain frequency (e.g., hundreds of hertz). The image processing side expands a specified range outward with the coordinates of the gaze point as a center. For example, as shown in FIG. 2, a 960×960 range is defined with the point O as a center as the user's gaze region (indicated by the dashed box in the figure).

In some embodiments, in response to a presence of a region, not covered by the original image, in the user's gaze region, coordinate translation is performed on the user's gaze region, such that the user's gaze region falls within a range of the original image.

In an exemplary embodiment, when the user's gaze point is located at an edge of the image, a case that the user's gaze region includes a region not covered by the original image may occur, as shown in the left diagram of FIG. 2. In this case, the coordinate translation may be performed on the entire user's gaze region to shift it into the original image. For example, a difference between coordinates of a boundary of the uncovered part of the user's gaze region and coordinates of a corresponding boundary of the original image may be calculated, so as to determine a distance required for the movement in each axis direction. As shown in the left diagram of FIG. 2, a Y-axis displacement Δy may be determined by calculating a difference between vertical coordinates of boundaries A1B1 and A2B2; an X-axis displacement Δx may be determined by calculating a difference between horizontal coordinates of boundaries A1C1 and A2C2 and taking an absolute value of the difference. The user's gaze region A1B1C1D1 is shifted according to the above-mentioned displacements, so that A1B1C1D1 falls into A2B2C2D2, as shown in the right diagram of FIG. 2. In some embodiments, when the user's gaze region is entirely covered by the original image, the first image may be saved as a texture. In this example, when the user's gaze point is located at the edge of the image, the validity of the user's gaze region is ensured by means of coordinate translation.

In some embodiments, a cached second image corresponding to the previous frame may be updated using the second image corresponding to the current frame.

In an exemplary embodiment, when the second image corresponding to the current frame is obtained, the second image may be cached. In order to save computing resources, the second image corresponding to the previous frame may be updated using the second image corresponding to the current frame.

In step S120, the similarity between the second image corresponding to the current frame and the second image corresponding to the previous frame is determined.

In the exemplary embodiment, an image similarity may be determined in various ways. For example, the similarity may be measured using distances (such as an absolute distance, a Euclidean distance, a Manhattan distance, etc.), or feature extraction may be performed first, and then similarity coefficients (such as a cosine similarity, various similarity coefficients, etc.) may be calculated.

For example, a difference between a pixel value at each position in the second image of the current frame and a pixel value at a corresponding position in the second image of the previous frame may be determined first; and then the determined differences may be weighted to determine the similarity.

In an exemplary embodiment, for each pair of corresponding positions in second images of adjacent frames, a difference in pixel values may be calculated first (i.e., an absolute distance is calculated), and then differences in the pixel values at different positions may be weighted. For a position corresponding to a respective difference in the pixel values, a weight value in the weighting may be determined based on a spacing between this position and the user's gaze point. For example, a larger weight is assigned to a position close to the user's gaze point, and a smaller weight is assigned to a position away from the user's gaze point. The weight value and the spacing between the pixel point and the user's gaze point may follow some relationship, such as a cubic Bézier curve, a sigmoid curve, or a relationship formed by modifying the above-mentioned curves, which will not be limited in this example. In some embodiments, normalization may be performed before the weighting operation.

For example, in each of the second image of the current frame and the second image of the previous frame, a first pixel region in the second image of the current frame and a second pixel region in the second image of the previous frame for the target movement position may be respectively determined by expanding from the user's gaze point serving as the center by a specified step size to a target movement position; differences in pixel values at corresponding positions between the first pixel region and the second pixel region may be summed, so as to acquire a sum corresponding to the target movement position; sums corresponding to respective target movement positions may be weighted; and the similarity may be determined based on a result of the weighting.

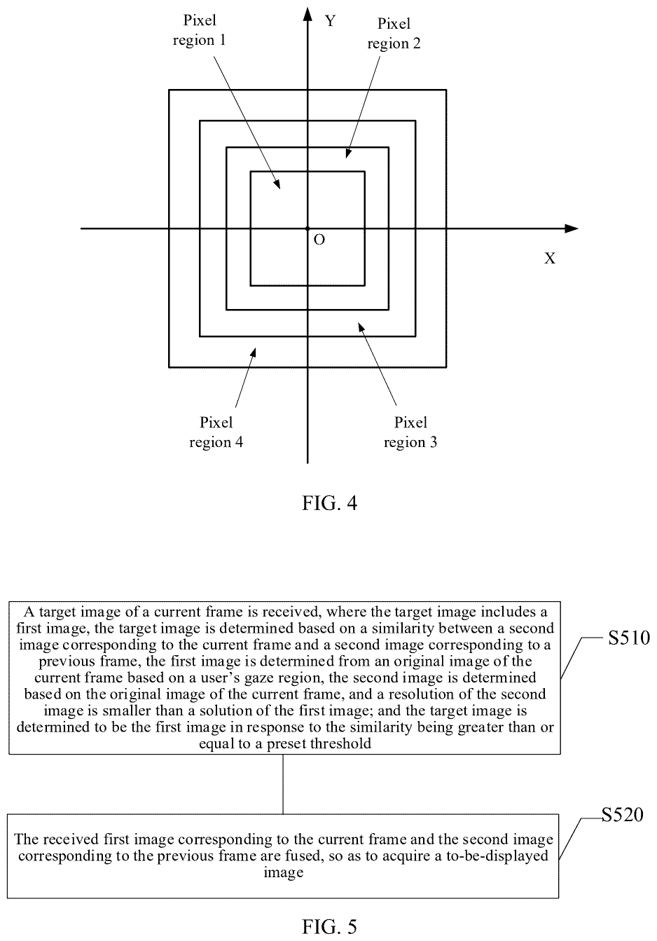

In the exemplary embodiment, the specified step size may be set as desired, and may be set to one or several pixels, etc., which will not be limited in this example. In each expansion process, by radiating outward from the user's gaze point serving as the center by a specified step size to reach the target movement position, a pixel region corresponding to the target movement position is determined. Pixels with the same or similar spacing from the user's gaze point may be divided into the same pixel region. That is, each expansion corresponds to one target movement position, and each target movement position corresponds to one pixel region. Each expansion is performed in each of the second image of the current frame and the second image of the previous frame, so as to determine the first pixel region in the second image of the current frame and the second pixel region in the second image of the previous frame for the target movement position, respectively. The same expansion operation may be performed on each of the two second images. As shown in FIG. 4, the expansion process is illustrated using the second image corresponding to the current frame as an example, in which the point O is the user's gaze point in the second image corresponding to the current frame. Expanding outward from the point O serving as the center, a first expansion obtains a pixel region 1, a second expansion obtains a pixel region 2, a third expansion obtains a pixel region 3, and a fourth expansion obtains a pixel region 4.

After obtaining the first pixel region and the second pixel region in the two second images, the differences in the pixel values at corresponding positions between the first pixel region and the second pixel region may be summed. That is, differences in pixel values in the two pixel regions determined for each target movement position may be summed, and then the sums corresponding to respective target movement positions may be weighted.

For example, a result of the weighting corresponding to the respective target movement positions may be calculated by:

$$sum = {\sum }_{j = 1}^{m} {W}_{j} {\sum }_{i = 1}^{n} {( \vert δ r \vert + \vert δ g \vert + \vert δ b \vert )}_{i} / 3 / 255$$

where sum represents the result of the weighting of the two second images, Wⱼ represents a weight value of a j^{th} target movement position, J represents the serial number of a target movement position, n represents a total number of pixels in the pixel region corresponding to the target movement position, i represents the serial number of a pixel in the pixel region corresponding to the target movement position, m represents a total number of target movement positions, δr, δg and δb respectively represent differences in R, G and B pixel values at corresponding positions of the two second images, and |•| represents taking an absolute value. In this formula, absolute differences of the R, G, B pixel values at each pixel position within the region are calculated, and the absolute differences are summed, then averaged, and then divided by 255 for normalization, so as to obtain a result of the weighting ranging between 0 and 1. This process is repeated until the target movement position reaches the boundary of the image, then the sum value is obtained.

In this example, the similarity is determined based on the result of the weighting, and the result of the weighting is inversely proportional to the similarity. For example, a reciprocal of the result of the weighting may be used as the similarity, or a mapping relationship may be established between the result of the weighting and the similarity, which will not be limited in this example.

For example, the weighting may be performed as follows: a weight assigned to a sum corresponding to each target movement position during the weighting is determined based on a spacing between this target movement position and the user's gaze point; and sums corresponding to the respective target movement positions are weighted using the weights.

In this exemplary embodiment, weighted summation may be performed by applying the weight of the target movement position corresponding to each spacing to the sums of the differences in the pixel values between the first pixel region and the second pixel region at this target movement position. Alternatively, the weighted summation may be performed after normalization, averaging or other processing is performed on the sums, which will not be limited in this example. For example, the weight for each pixel region may be determined based on an improved sigmoid curve. The specific formula is as follows:

$${W}_{j} = 0.5 \times \frac{1}{( 1 + exp ( - \frac{5}{1920} \times \vert s \vert ) )}$$

where S represents a spacing between a target movement position j and the user's gaze point.

For example, FIG. 4 is a schematic diagram where weights at each target movement position satisfy a cubic Bézier curve. In FIG. 4, the user's gaze point in the second image corresponding to the current frame is the point O, and the second image is divided into four pixel regions. A weight corresponding to the pixel region 1 is 0.45, a weight corresponding to the pixel region 2 is 0.35, a weight corresponding to the pixel region 3 is 0.15, and a weight corresponding to the pixel region 4 is 0.05.

In the embodiments of the present disclosure, the weight used in the weighting may be determined based on a spacing between the target movement position and the user's gaze point, thereby introducing the factor of user attention into the similarity calculation. A larger weight is assigned to a region with higher user attention (positions close to the gaze point), and a smaller weight is assigned to a region with low user attention (positions away from the gaze point). In this way, while considering the differences in pixel values between two second images, the influence of user attention may also be taken into account, which may reduce the impact on user experience caused by replacing the second image corresponding to the previous frame with the second image corresponding to the current frame, thereby ensuring the user experience.

In step S130, the target image is transmitted based on the similarity.

In an exemplary embodiment, the similarity being greater than or equal to the preset threshold means that the difference between two adjacent frames is small, then the target image is determined to be the first image. That is, only the first image of the current frame is transmitted, and regions of the current frame other than the region corresponding to the first image are not transmitted, which may reduce the data transmission volume of the current frame and thus the bandwidth pressure, while ensuring the clarity of the first image corresponding to the user's gaze region, thereby ensuring the user experience. The preset threshold may be set based on the complexity of the actual scene of the image. For example, in case of a simple scene, a large preset threshold may be applied; and in a case of a complex scene where a difference between two frames of images is inherently large, a small preset threshold may be applied.

In some embodiments, before the data transmission, encoding for transmission may be performed on the to-be-transmitted data, namely the target image, so as to facilitate network transmission. After receiving the data (the encoded target image), a receiving end may decode the received data (the encoded target image) to restore the information.

In some embodiments, in a case that the similarity is less than the preset threshold, the first image corresponding to the current frame and the second image corresponding to the current frame are both transmitted.

In the exemplary embodiments, the similarity being less than the preset threshold means that the difference between two adjacent frames (the current frame and the previous frame) is large, then the first image corresponding to the current frame and the corresponding second image are both transmitted. In this example, when the difference between the adjacent frames is large, by transmitting a low-resolution version of the original image and a high-resolution image corresponding to the user's gaze region, while ensuring clarity of the user's region of interest, a bandwidth pressure caused by transmitting a full high-definition image may be reduced by transmitting the low-resolution image. As such, real-time requirements may be satisfied, thereby improving the user experience.

Referring to FIG. 5, the present disclosure further provides an image processing method, which is applied to a device side. The method may include the following steps S510 to S520.

In step S510, a target image of a current frame is received, where the target image includes a first image, the target image is determined based on a similarity between a second image corresponding to the current frame and a second image corresponding to a previous frame, the first image is determined from an original image of the current frame based on a user's gaze region, the second image is determined based on the original image of the current frame, and a resolution of the second image is smaller than a solution of the first image; and the target image is determined to be the first image in response to the similarity being greater than or equal to a preset threshold.

In step S520, the received first image corresponding to the current frame and the second image corresponding to the previous frame are fused, so as to acquire a to-be-displayed image.

In the exemplary embodiments, when the received target image is determined to be the first image, the first image corresponding to the current frame and the second image corresponding to the previous frame may be fused, so as to fuse a high-resolution first image into a low-resolution second image, thereby forming an image where a resolution of the user's gaze region is high and a resolution of other regions is low.

In some embodiments, when the target image includes both the first image corresponding to the current frame and the second image corresponding to the current frame, an image fusion process is performed on the first image corresponding to the current frame and the second image corresponding to the current frame, so as to acquire the to-be-displayed image.

For example, the image fusion process may include: first performing size restoration on a to-be-fused second image to acquire a corresponding third image, where a size of the third image is equal to a size of a corresponding original image; fusing the first image and the third image such that the first image covers a corresponding position of the third image, so as to acquire a corresponding fourth image; and smoothing a fusion boundary in the fourth image, so as to acquire the to-be-displayed image.

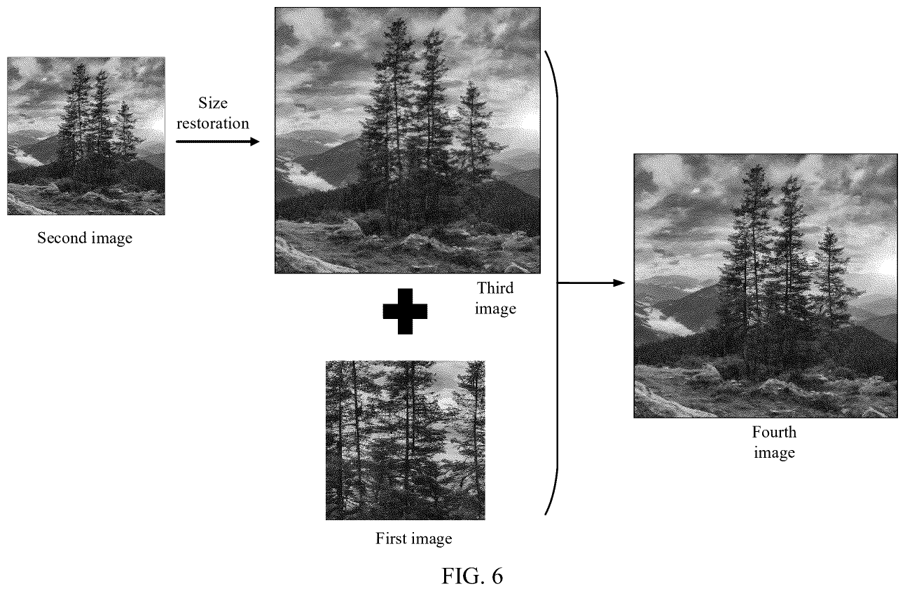

In the exemplary embodiments, the to-be-fused second image may be the second image corresponding to the current frame or the second image corresponding to the previous frame, and the to-be-fused second image may be determined based on the object of the image fusion process. In this example, the size restoration may be achieved by means of upsampling, the position of the first image in the third image may be determined, the first image may cover a corresponding position in the third image, and then the smoothing may be performed on fused boundaries between the first image and the third image, so as to acquire the to-be-displayed image. For example, the images involved in the fusion process are shown in FIG. 6.

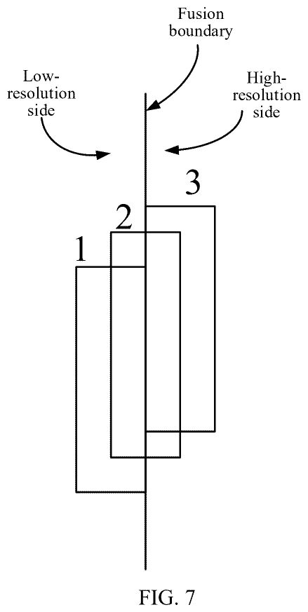

In the exemplary embodiments, the smoothing processing refers to smoothing of boundaries between high-resolution and low-resolution regions in an image. The smoothing processing may include one or more rounds of filtering, such as mean filtering, Gaussian filtering, etc. The types of filtering in different rounds may be the same or different, which will not be limited in this example. As shown in FIG. 7, three rounds of Gaussian filtering may be performed on the fusion boundary, and the three rounds of Gaussian filtering may be performed sequentially from the low-resolution region to the high-resolution region. The sequence of the filtering in FIG. 7 is indicated as 1, 2, and 3.

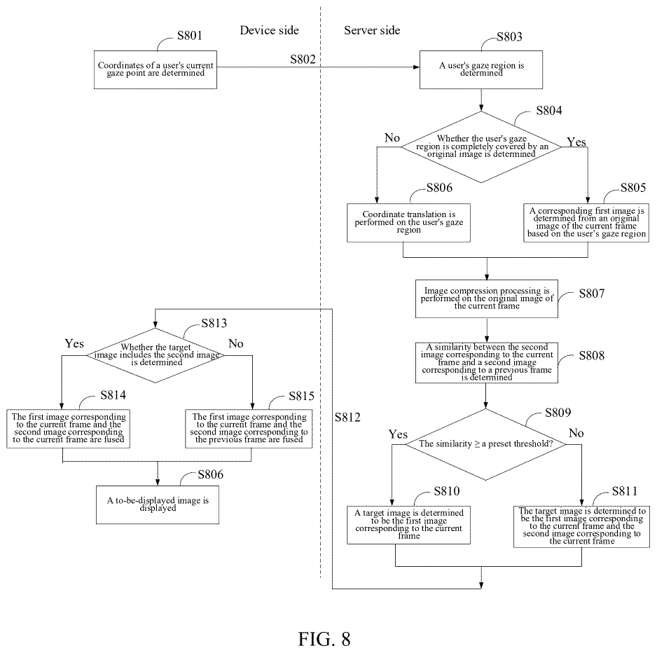

Referring to FIG. 8, an image processing method provided in another embodiment of the present disclosure may include the following steps.

In step S801, a device side determines coordinates of a user's current gaze point using an eye tracking method.

In step S802, the device side sends the coordinates of the user's gaze point to a server side.

In step S803, the server side determines a user's gaze region based on the coordinates of the user's gaze point.

In step S804, the server side determines whether the user's gaze region is entirely covered by the original image; if yes, the process proceeds to step S805; otherwise, the process proceeds to step S806.

In step S805, the server side performs coordinate translation on the user's gaze region, such that the user's gaze region falls within a range of the original image, and the process returns to step S805.

In step S806, the server side determines a first image corresponding to the original image of the current frame based on the user's gaze region.

In step S807, the server side performs image compression processing on the original image of the current frame, so as to acquire a second image corresponding to the current frame.

In step S808, the server side determines a similarity between the second image corresponding to the current frame and a second image corresponding to a previous frame.

In step S809, the server side determines whether the similarity is greater than or equal to a preset threshold; if yes, the process proceeds to step S810; otherwise, the process proceeds to step S811.

In step S810, the server side determines the target image to be the first image corresponding to the current frame, and the process proceeds to step S812.

In step S811, the server side determines the target image to be the first image corresponding to the current frame and the second image corresponding to the current frame, and the process returns to step S811.

In step S812, the server side transmits the target image to the device side.

In step S813, the device side determines whether the target image includes the second image; if yes, the process proceeds to step S814; otherwise, the process proceeds to step S815.

In step S814, the device side fuses the first image corresponding to the current frame and the second image corresponding to the current frame, so as to acquire a to-be-displayed image, and then the process proceeds to step S816.

In step S815, the device side fuses the first image corresponding to the current frame and the second image corresponding to the previous frame, so as to acquire the to-be-displayed image, and then the process proceeds to step S816.

In step S816, the device side displays the to-be-displayed image.

In the above embodiments, the image fusion process may be executed in a processor of the device side or performed in a display of the device side, which will not be limited in this example.

According to the image processing method provided in the present disclosure, on one hand, the first image of the current frame is determined based on the user's gaze region and then transmitted, which may ensure image clarity of the user's region of interest and the informational integrity of the user's region of interest, thereby ensuring the user experience. On the other hand, the second image of the current frame, which has a resolution smaller than that of the first image, may be determined based on the original image of the current frame, and in the case where the similarity between the second image of the current frame and the second image of the previous frame is greater than the preset threshold, only the first image of the current frame is transmitted. As such, it is possible to reduce the data transmission volume of the current frame in a case of a high similarity between two adjacent frames, reduce a network bandwidth pressure, ensure real-time data transmission, which may prevent freezing and high latency phenomena, thereby improving the user experience.

Embodiments of device in the present disclosure is described below, which may be used to perform the above-mentioned image processing method of the present disclosure. For the details not disclosed in the apparatus embodiments of the present disclosure, please refer to the embodiments of the above-mentioned image processing method of the present disclosure.

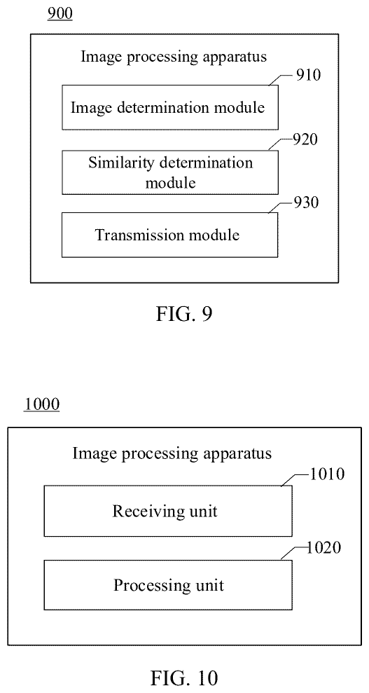

FIG. 9 schematically shows a block diagram of an image processing device according to an embodiment of the present disclosure.

Referring to FIG. 9, an image processing device 900 according to an embodiment of the present disclosure includes: an image determination module 910, a similarity determination module 920, and a transmission module 930.

The image determination module 910 is configured to: determine, from an original image of a current frame, a corresponding first image based on a user's gaze region; and determine a corresponding second image based on the original image of the current frame, where a resolution of the second image is smaller than a solution of the first image. The similarity determination module 920 is configured to determine a similarity between the second image corresponding to the current frame and a second image corresponding to a previous frame. The transmission module 930 is configured to transmit a target image based on the similarity, where the target image is determined to be the first image in response to the similarity being greater than or equal to a preset threshold.

In some embodiments of the present disclosure, based on the above-mentioned solutions, the similarity determination module 920 includes a pixel difference determination sub-module and a weighting sub-module. The pixel difference determination sub-module is configured to determine a difference between a pixel value at each position in the second image of the current frame and a pixel value at a corresponding position in the second image of the previous frame; and the weighting sub-module is configured to weight the determined differences to determine the similarity.

In some embodiments of the present disclosure, based on the above-mentioned solutions, the weighting sub-module is further configured to: in each of the second image of the current frame and the second image of the previous frame, expand from a user's gaze point serving as a center by a specified step size to a target movement position, so as to determine a first pixel region in the second image of the current frame and a second pixel region in the second image of the previous frame for the target movement position respectively; sum differences in pixel values at corresponding positions between the first pixel region and the second pixel region, so as to acquire a sum corresponding to the target movement position; weight sums corresponding to respective target movement positions; and determine the similarity based on a result of the weighting.

In some embodiments of the present disclosure, based on the above-mentioned solutions, the weighting sub-module is further configured to: determine a weight value of a sum corresponding to each target movement position in the weighting based on a spacing between the target movement position and the user's gaze point; and weight the sums corresponding to the respective target movement positions using the weight value.

In some embodiments of the present disclosure, based on the above-mentioned solutions, the apparatus 900 further includes a translation module configured to: before the first image is determined, perform, in response to a presence of a region, not covered by the original image, in the user's gaze region, coordinate translation on the user's gaze region, such that the user's gaze region falls within a range of the original image.

In some embodiments of the present disclosure, based on the above-mentioned solutions, the transmission module 930 is further configured to: transmit, in response to the similarity being less than the preset threshold, the first image corresponding to the current frame and the second image corresponding to the current frame.

In some embodiments of the present disclosure, based on the above-mentioned solutions, the apparatus 900 further includes an acquisition module configured to: acquire coordinates of the user's gaze point; and expand a specified range outward with the coordinates of the user's gaze point as a center, so as to determine the user's gaze region.

In some embodiments of the present disclosure, based on the above-mentioned solutions, the apparatus 900 further includes a cache update module configured to update a cached second image corresponding to the previous frame using the second image corresponding to the current frame.

FIG. 10 shows a block diagram of an image processing device according to other embodiments of the present disclosure. Referring to FIG. 10, an image processing device 1000 according to an embodiment of the present disclosure includes: a receiving unit 1010 and a processing unit 1020. The receiving unit 1010 is configured to receive a target image of a current frame, where the target image includes a first image, the target image is determined based on a similarity between a second image corresponding to the current frame and a second image corresponding to a previous frame, the first image is determined from an original image of the current frame based on a user's gaze region, the second image is determined based on the original image of the current frame, and a resolution of the second image is smaller than a solution of the first image; and the target image is determined to be the first image in response to the similarity being greater than or equal to a preset threshold; and the processing unit 1020 is configured to fuse the received first image corresponding to the current frame and the second image corresponding to the previous frame, so as to acquire a to-be-displayed image.

In some embodiments of the present disclosure, based on the above-mentioned solutions, the target image includes the first image corresponding to the current frame and the second image corresponding to the current frame, and the processing unit 1020 is further configured to: fuse the first image corresponding to the current frame and the second image corresponding to the current frame, so as to acquire a to-be-displayed image.

In some embodiments of the present disclosure, based on the above-mentioned solutions, the processing unit 1020 is further configured to: perform size restoration on a to-be-fused second image to acquire a corresponding third image, where a size of the third image is equal to a size of a corresponding original image; and the to-be-fused second image is the second image corresponding to the current frame or the second image corresponding to the previous frame; fuse the first image and the third image such that the first image covers a corresponding position of the third image, so as to acquire a corresponding fourth image; and smooth a fusion boundary in the fourth image, so as to acquire the to-be-displayed image.

The specific details of the above-mentioned image processing devices are described in detail in the corresponding image processing methods, which will not be repeated here.

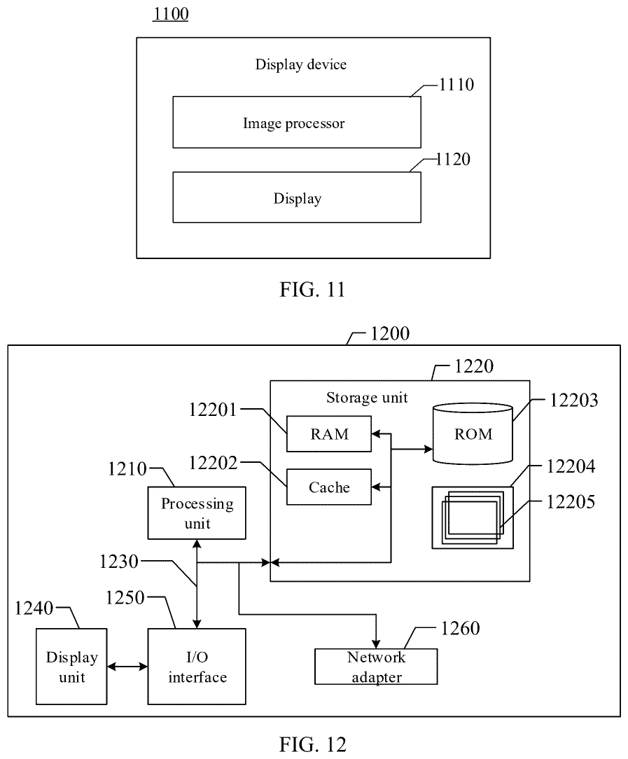

The embodiments of the present disclosure further provide a display apparatus, including the image processing device according to any one of the above-mentioned embodiments. FIG. 11 shows a block diagram of a display apparatus according to some embodiments of the present disclosure. Referring to FIG. 11, a display apparatus provided in the present disclosure includes: an image processor 1110 and a display 1120. The image processor 1110 is configured to implement the image processing method according to any one of the above-mentioned embodiments. The display 1120 is configured to display the to-be-displayed image. In some embodiments, the display may include at least one of a liquid crystal display (LCD) or an organic light-emitting diode (OLED) display. In some embodiments, the display apparatus may be any product or component with a display function, such as a mobile phone, a tablet computer, a television, a notebook computer, a digital photo frame, a navigator, etc.

The embodiments of the present disclosure further provide a virtual reality display system, including the display apparatus according to any one of the above-mentioned embodiments. By using the display apparatus in the embodiments of the present disclosure, real-time performance of a large-scale VR system may be ensured.

It should be noted that, although several modules or units of the device for execution have been mentioned in the above-mentioned detailed descriptions, this division is not mandatory. In fact, according to embodiments of the present disclosure, the features and functions of two or more modules or units described above may be embodied in one module or unit. On the contrary, the features and functions of one module or unit described above may be further divided to be embodied by a plurality of modules or units.

In the exemplary embodiment, an electronic device capable of implementing the above-mentioned method is further provided.

Those skilled in the art may understand that various aspects of the present disclosure may be implemented as a system, a method, or a program product. Therefore, various aspects of the present disclosure may be specifically implemented in the following forms, i.e., a complete hardware embodiment, a complete software embodiment (including firmware, microcode, etc.), or an embodiment of a combination of hardware and software aspects, which may be collectively referred to as a “circuit”, “module” or “system”.

An electronic device 1200 according to such embodiments of the present disclosure will be described below with reference to FIG. 12. The electronic device 1200 shown in FIG. 12 is only an example, and should not constitute any limitation on the functions and application scope of embodiments of the present disclosure.

As shown in FIG. 12, the electronic device 1200 is represented in a form of a general-purpose computing device. Components of the electronic device 1200 may include but are not limited to: at least one processing unit 1210, at least one storage unit 1220, a bus 1230 connecting different system components (including the storage unit 1220 and the processing unit 1210), and a display unit 1240.

The storage unit stores program codes, which when executed by the processing unit 1210 cause the processing unit 1210 to perform the steps according to various exemplary embodiments of the present disclosure in the above-mentioned image processing method of the specification. For example, the processing unit 1210 may perform: as shown in FIG. 1, step S110 of determining, based on a user's gaze region, a corresponding first image from an original image of the current frame; and determining a corresponding second image based on the original image of the current frame, where a resolution of the second image is smaller than a solution of the first image; step S120 of determining a similarity between the second image corresponding to the current frame and a second image corresponding to a previous frame; and step S130 of transmitting a target image based on the similarity, where the target image is determined to be the first image in response to the similarity being greater than or equal to a preset threshold.

The storage unit 1220 may include a readable medium in the form of a volatile storage unit, such as a random access storage unit (RAM) 12201 and/or a cache storage unit 12202, and may further include a read-only storage unit (ROM) 12203.

The storage unit 1220 may further include a program/utility tool 12204 having a set (at least one) of program modules 12205. Such program modules 12205 include, but are not limited to: an operating system, one or more application programs, other program modules, and program data. Each of these examples or a combination thereof may include an implementation of a network environment.

The bus 1230 may represent one or more of several types of bus structures, including a storage unit bus or a storage unit controller, a peripheral bus, an accelerated graphics port, a processing unit, or a local bus using any of a variety of bus structures.

The electronic device 1200 may also communicate with one or more external devices (such as a keyboard, pointing device, Bluetooth device, etc.), and may further communicate with one or more devices that enable a user to interact with the electronic device 1200, and/or communicate with any device (such as a router, modem, etc.) that enables the electronic device 1200 to communicate with one or more other computing devices. Such communication may be performed through an input/output (I/O) interface 1250. Furthermore, the electronic device 1200 may also communicate with one or more networks (such as a Local region Network (LAN), Wide region Network (WAN), and/or a public network, e.g., the Internet) via a network adapter 1260. As shown in the figure, the network adapter 1260 communicates with other modules of the electronic device 1200 through the bus 1230. It should be understood that, although not shown in the figure, other hardware and/or software modules may be used in combination with the electronic device 1200, including but not limited to: microcode, a device driver, a redundant processing unit, an external disk drive array, a RAID system, a tape drive, and a data backup storage system, etc.

Through the descriptions of the above-mention embodiments, those skilled in the art will appreciate that the exemplary embodiments described herein may be implemented by software alone, or by software combined with necessary hardware. Therefore, the technical solutions according to embodiments of the present disclosure may be embodied in a form of a software product, and the software product may be stored in a non-volatile storage medium (such as a CD-ROM, USB flash drive, mobile hard disk, etc.) or on the network, and includes several instructions to cause a computing device (which may be a personal computer, server, terminal device, or network device, etc.) to implement the method according to embodiments of the present disclosure.

In the exemplary embodiment, a computer-readable storage medium having a program product capable of implementing the above-mentioned methods in the specification stored thereon is further provided. In some possible embodiments, various aspects of the present disclosure may also be implemented in a form of a program product, which includes program codes. The program product, when running on a terminal device, is used to cause the terminal device to execute the steps according to various exemplary embodiments of the present disclosure described in the above-mentioned “exemplary methods” section of the specification.

The program product for implementing the above-mentioned methods according to embodiments of the present disclosure may use a portable compact disc read-only memory (CD-ROM) and include program codes, and may run on a terminal device, such as a personal computer. However, the program product of the present disclosure will not be limited thereto. In the present disclosure, a readable storage medium may be any tangible medium that contains or stores a program, and the program may be used by or in combination with an instruction execution system, apparatus, or device.

The program product may use any combination of one or more readable media. The readable medium may be a readable signal medium or a readable storage medium. The readable storage medium may be, for example, but not limited to, an electrical, magnetic, optical, electromagnetic, infrared, or semiconductor system, apparatus, or device, or any combination thereof. More specific examples (a non-exhaustive list) of the readable storage medium include: an electrical connection with one or more wires, a portable disk, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination thereof.

A computer-readable signal medium may include a data signal propagated in baseband or as part of a carrier wave, in which readable program codes are carried. Such a propagated data signal may take various forms, including but not limited to an electromagnetic signal, an optical signal, or any suitable combination thereof. A readable signal medium may also be any readable medium other than the readable storage medium, and the readable medium may send, propagate, or transmit the program for use by or in combination with an instruction execution system, apparatus, or device.

The program codes contained on the readable medium may be transmitted via any appropriate medium, including but not limited to wireless, wired, optical cable, radio frequency (RF), etc., or any suitable combination thereof.

The program codes for performing the operations of the present disclosure may be written in any combination of one or more programming languages. The programming languages include object-oriented programming languages-such as Java, C++, etc., and also include conventional procedural programming languages-such as a “C” language or similar programming languages. The program codes may be executed completely on a user's computing device, executed partially on a user's device, executed as an independent software package, executed partially on the user's computing device and partially on a remote computing device, or executed completely on the remote computing device or a server. In a case of involving a remote computing device, the remote computing device may be connected to the user's computing device via any type of network, including a Local Area Network (LAN) or a Wide Area Network (WAN), or may be connected to an external computing device (e.g., via the Internet using an Internet service provider).

In addition, the above-mentioned accompanying drawings are merely schematic illustrations of the processes included in the methods according to exemplary embodiments of the present disclosure, and are not for limiting purpose. It will be appreciated that the processes shown in the above-mentioned accompanying drawings do not indicate or limit the time sequence of these processes. Furthermore, it will also be appreciated that these processes may be, for example, executed synchronously or asynchronously in a plurality of modules.

After considering the specification and practicing the present disclosure herein, those skilled in the art may easily conceive of other embodiments of the present disclosure. The application is intended to cover any variations, uses, or adaptive changes of the present disclosure. These variations, uses, or adaptive changes comply with the general principles of the present disclosure and include common knowledge or conventional technical means in the technical field not disclosed in the present disclosure. The specification and embodiments are to be regarded as exemplary only, and the true scope and spirit of the present disclosure are indicated by the appended claims.

It will be understood that the present disclosure is not limited to the precise structure that has been described above and shown in the accompanying drawings, and various modifications and changes may be made without departing from the scope of the present disclosure. The scope of the present disclosure is only limited by the appended claims.

1. An image processing method, comprising:
determining, from an original image of a current frame, a corresponding first image based on a user's gaze region; and determining a corresponding second image based on the original image of the current frame, wherein a resolution of the second image is smaller than a solution of the first image;
determining a similarity between the second image corresponding to the current frame and a second image corresponding to a previous frame; and
transmitting a target image based on the similarity, wherein the target image is determined to be the first image in response to the similarity being greater than or equal to a preset threshold.

2. The method according to claim 1, wherein the determining a similarity between the second image corresponding to the current frame and a second image corresponding to a previous frame comprises:
determining a difference between a pixel value at each position in the second image of the current frame and a pixel value at a corresponding position in the second image of the previous frame; and
weighting the determined differences to determine the similarity.

3. The method according to claim 2, wherein the weighting differences in pixel values at each position comprises:
in each of the second image of the current frame and the second image of the previous frame, expanding from a user's gaze point serving as a center by a specified step size to a target movement position, so as to determine a first pixel region in the second image of the current frame and a second pixel region in the second image of the previous frame for the target movement position respectively;
summing differences in pixel values at corresponding positions between the first pixel region and the second pixel region, so as to acquire a sum corresponding to the target movement position;
weighting sums corresponding to respective target movement positions; and
determining the similarity based on a result of the weighting.

4. The method according to claim 3, wherein the weighting sums corresponding to respective target movement positions comprises:
determining a weight value of a sum corresponding to each target movement position in the weighting based on a spacing between the target movement position and the user's gaze point; and
weighting the sums corresponding to the respective target movement positions using the weight value.

5. The method according to claim 1, further comprising: before determining the first image,
performing, in response to a presence of a region, not covered by the original image, in the user's gaze region, coordinate translation on the user's gaze region, such that the user's gaze region falls within a range of the original image.

6. The method according to claim 1, wherein the transmitting a target image based on the similarity comprises:
transmitting, in response to the similarity being less than the preset threshold, the first image corresponding to the current frame and the second image corresponding to the current frame.

7. The method according to claim 1, further comprising:
acquiring coordinates of the user's gaze point; and
expanding a specified range outward with the coordinates of the user's gaze point as a center, so as to determine the user's gaze region.

8. The method according to claim 1, further comprising:
updating a cached second image corresponding to the previous frame using the second image corresponding to the current frame.

9. An image processing method, comprising:
receiving a target image of a current frame, wherein the target image comprises a first image, the target image is determined based on a similarity between a second image corresponding to the current frame and a second image corresponding to a previous frame, the first image is determined from an original image of the current frame based on a user's gaze region, the second image is determined based on the original image of the current frame, and a resolution of the second image is smaller than a solution of the first image; and the target image is determined to be the first image in response to the similarity being greater than or equal to a preset threshold; and
fusing the received first image corresponding to the current frame and the second image corresponding to the previous frame, so as to acquire a to-be-displayed image.

10. The method according to claim 9, wherein the target image comprises the first image corresponding to the current frame and the second image corresponding to the current frame, and the method further comprises:
fusing the first image corresponding to the current frame and the second image corresponding to the current frame, so as to acquire the to-be-displayed image.

11. The method according to claim 9, wherein the fusing comprises:
performing size restoration on a to-be-fused second image to acquire a corresponding third image, wherein a size of the third image is equal to a size of a corresponding original image, and the to-be-fused second image is the second image corresponding to the current frame or the second image corresponding to the previous frame;
fusing the first image and the third image such that the first image covers a corresponding position of the third image, so as to acquire a corresponding fourth image; and
smoothing a fusion boundary in the fourth image, so as to acquire the to-be-displayed image.

12. (canceled)

13. (canceled)

14. A display apparatus, comprising:
an image processor configured to implement the method according to claim 9; and
a display configured to display the to-be-displayed image.

15. A virtual reality display system, comprising: the display apparatus according to claim 14.

16. An electronic device, comprising:
one or more processors; and
a storage device configured to store one or more programs, wherein the one or more programs, when executed by the one or more processors, are configured to cause the one or more processors to implement the method according to claim 1.

17. A non-transitory computer-readable storage medium having a computer program stored therein, wherein the computer program, when executed by a processor, is configured to implement the method according to claim 1.

18. The method according to claim 10, wherein the fusing comprises:
performing size restoration on a to-be-fused second image to acquire a corresponding third image, wherein a size of the third image is equal to a size of a corresponding original image, and the to-be-fused second image is the second image corresponding to the current frame or the second image corresponding to the previous frame;
fusing the first image and the third image such that the first image covers a corresponding position of the third image, so as to acquire a corresponding fourth image; and
smoothing a fusion boundary in the fourth image, so as to acquire the to-be-displayed image.

19. The method according to claim 3, wherein the weighting sums corresponding to respective target movement positions comprises:
calculating a result of the weighting corresponding to the respective target movement positions by:
$$sum = {\sum }_{j = 1}^{m} {W}_{j} {\sum }_{i = 1}^{n} {( \vert δ r \vert + \vert δ g \vert + \vert δ b \vert )}_{i} / 3 / 255$$
where sum represents the result of the weighting of the two second images, Wⱼ represents a weight value of a j^{th} target movement position, j represents the serial number of a target movement position, n represents a total number of pixels in the pixel region corresponding to the target movement position, i represents the serial number of a pixel in the pixel region corresponding to the target movement position, m represents a total number of target movement positions, δr, δg and δb respectively represent differences in R, G and B pixel values at corresponding positions of the two second images, and |•| represents taking an absolute value.

20. The method according to claim 4, wherein the determining a weight value of a sum corresponding to each target movement position in the weighting based on a spacing between the target movement position and the user's gaze point comprises:
calculating the weight value by:
$${W}_{j} = 0.5 \times \frac{1}{( 1 + exp ( - \frac{5}{1920} \times \vert s \vert ) )}$$
where Wⱼ represents a weight value of a j^{th} target movement position, j represents the serial number of a target movement position, S represents a spacing between the j^{th} target movement position and the user's gaze point.
